(19) United States
(12) Patent Application Publication
(10) Pub. No.: US 2026/0111805 A1
(43) Pub. Date: Apr. 23, 2026

(54) System

(71) Applicant: Softbank Group Corp., Tokyo (JP)

(72) Inventor: Takahiro Shinkai, Tokyo (JP)

(21) Appl. No.: 19/360,735

(22) Filed: Oct. 16, 2025

(30) Foreign Application Priority Data
Oct. 18, 2024 (JP) 2024-183756

(51) Int. Cl. G06Q 10/047; G05D 1/24; G05D 1/644; G05D 107/70; G05D 109/10; G05D 111/30; G06Q 10/0633

(52) U.S. Cl. CPC G06Q 10/047; G05D 1/24; G05D 1/644; G06Q 10/0633; G05D 2107/70; G05D 2109/10; G05D 2111/32

(57) ABSTRACT

A system includes a processor that is configured to analyze position information and environmental information received from a mobile device and a peripheral device using a generation module, to acquire real-time movement data and environmental information utilizing a communication infrastructure, and to generate optimized workflows and movement routes, and to transmit instructions to the mobile device based on the analysis results.

### CROSS-REFERENCE TO RELATED APPLICATION

This application is based on and claims priority under 35 USC 119 from Japanese Patent Application No. 2024-183756 filed on Oct. 18, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional systems for managing the operation of mobile devices and peripheral devices, there exist significant challenges in achieving real-time optimization of workflows and movement routes, especially when integrating diverse sources of position and environmental information. Current solutions often suffer from delays, inefficient task allocation, and suboptimal energy consumption, particularly in complex environments such as logistics centers or large warehouses. Furthermore, the inability to efficiently utilize critical data such as battery status or obstacle detection information results in decreased productivity and increased operational costs.

### SUMMARY

The present invention provides a system comprising a processor configured to analyze position information and environmental information received from mobile devices and peripheral devices using a generation module. The processor is further configured to acquire real-time movement data and environmental information through a communication infrastructure, and to generate optimized workflows and movement routes. Instructions based on this analysis are then transmitted to mobile devices, enabling efficient task and route allocation. The system can analyze key data such as battery status and obstacle information, and leverage next-generation communication technologies to ensure rapid, reliable data transfer and real-time response, thereby maximizing operational efficiency and sustainability.

“Processor” means a hardware component or circuitry capable of executing programmed instructions and performing data processing tasks within the system. “Generation module” means a software or hardware module configured to analyze information from mobile devices and peripheral devices to generate optimized workflows and movement routes. “Mobile device” means a movable piece of equipment, such as a robot or automated vehicle, capable of performing tasks and reporting position and status information within the system. “Peripheral device” means an external device, such as a sensor or beacon, which provides supplementary data including environmental and positional information to the system. “Position information” means data indicating the physical location, orientation, or movement coordinates of a mobile device or peripheral device within a specified environment. “Environmental information” means data describing the conditions of the surrounding area, such as temperature, humidity, lighting, and other measurable parameters relevant to system operation. “Communication infrastructure” means network hardware and software enabling the transfer of data between system components, including wired or wireless communication technologies. “Workflow” means a sequence or process of tasks and operations to be performed by mobile devices and managed by the system for optimized task allocation. “Movement route” means a calculated pathway or trajectory for a mobile device to follow in order to accomplish assigned tasks efficiently. “Battery status” means information describing the current energy level or remaining charge of a mobile device's power source. “Obstacle information” means data indicating the presence, location, or nature of objects which may interfere with or block the movement of a mobile device. “Next-generation communication technology” means advanced wireless or wired network technologies, such as 5G or beyond, which offer high-speed, low-latency, and reliable data transmission capabilities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

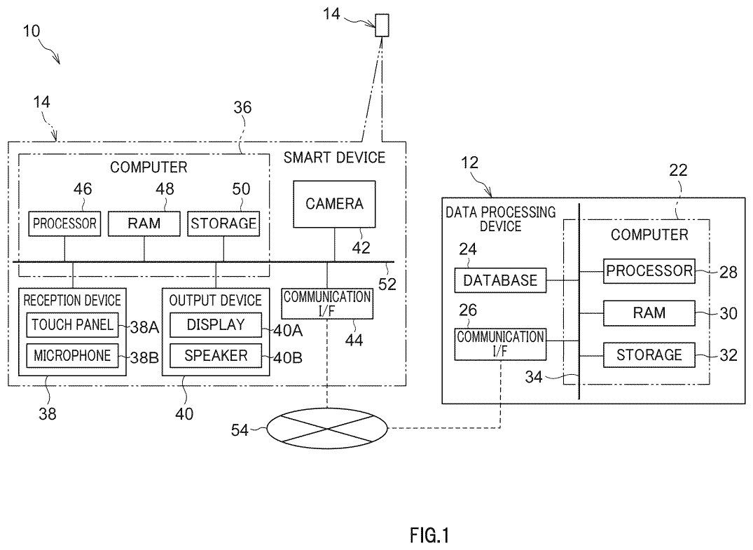

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

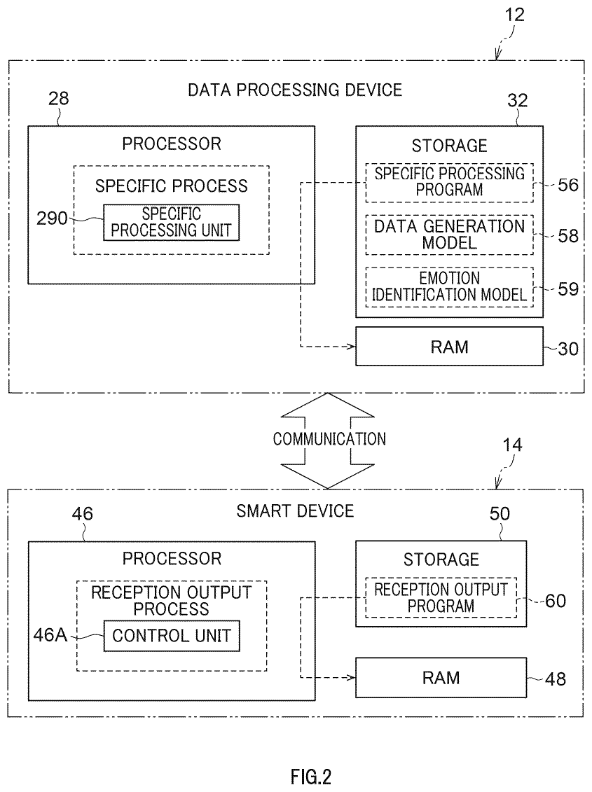

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

There is a need for a system that can efficiently collect and analyze real-time location and environmental information from a plurality of information processing devices and information acquisition devices, such as moving devices and peripheral sensors, and dynamically optimize workflows and movement routes with high speed and precision. Existing systems often suffer from data processing delays, insufficient adaptation to changing environments or user input, lack of real-time route optimization, and inefficiency in utilizing user feedback for continuous improvement. These shortcomings can lead to inefficient operations, increased energy consumption, and reduced productivity in environments such as logistics centers, automated warehouses, and smart factories.

The specific processing by the specific processing unit 290 of the data processing device 12 in Example 1 is realized by the following means.

The present invention provides a server comprising a processor configured to perform preprocessing, such as noise removal, feature extraction, and pattern recognition, on real-time sensor data received via a network infrastructure from multiple devices; to execute a generative artificial intelligence model for optimizing workflows and movement routes; to aggregate and store input data and feedback information; to generate and transmit optimized operation instructions to terminal devices; and to utilize user feedback and prompt sentences as training data for the generative artificial intelligence model. This enables high-precision, real-time optimization of operational procedures and movement routes, continuous system improvement through adaptive machine learning, efficient visualization and command distribution, and effective utilization of user feedback, thus solving inefficiencies in performance, adaptability, and energy consumption.

The term “processor” refers to a computing unit or central processing hardware that executes instructions, processes data, and controls operations within a computer system. The term “information processing device” refers to a device that performs computational tasks, data processing, or execution of instructions, such as a mobile device, robot, or any computing terminal involved in the workflow. The term “information acquisition device” refers to an apparatus, such as a sensor or peripheral unit, that collects and provides data related to location, environmental conditions, or operational states to the system. The term “location information” refers to data that indicates the geographical, spatial, or positional status of a device, including coordinates, altitude, or other traceable attributes. The term “surrounding information” refers to data indicating the physical or environmental state around an information processing device, such as temperature, humidity, obstacle presence, or other environmental parameters. The term “network infrastructure” refers to the underlying communication system, including hardware and software components, that enables real-time data transmission and connectivity between devices in the system. The term “generative artificial intelligence model” refers to a machine learning model capable of generating outputs, such as optimized workflows or commands, by learning from input data and user directives, and continuously improving through accumulated data and feedback. The term “workflow” refers to an organized sequence of tasks, operations, or processes carried out by the information processing devices according to optimized instructions. The term “movement route” refers to an optimized path or series of waypoints calculated for a moving device to efficiently complete its assigned tasks. The term “prompt sentence” refers to a user-generated textual or structured instruction provided to the generative artificial intelligence model to specify desired operational constraints or preferences for optimization. The term “command data” refers to output instructions, calculated and transmitted by the processor, that direct device actions or operations based on optimization results and user input. The term “terminal device” refers to an interface-equipped computing device that displays command data, accepts user operations or input, and transmits user feedback to the processor. The term “user interface” refers to the means by which a user interacts with the terminal device, including graphical displays, touch screens, or voice input systems. The term “feedback information” refers to data or comments provided by the user indicative of system performance, operational issues, or improvement suggestions, which are transmitted back to the processor. The term “historical data” refers to the accumulated records of device operations, user feedback, and prompt sentences, which are stored and used for continuous learning and optimization by the system. The term “training data” refers to the collection of input examples, including historical operations and user feedback, utilized to train or refine the generative artificial intelligence model for improved performance.

An embodiment of the invention will be described in detail below. A system according to this embodiment comprises a server, a plurality of terminal devices, information processing devices, and information acquisition devices (such as environmental sensors or peripheral measurement equipment), all connected via a high-speed network infrastructure, for example wireless LAN, 5G, or other next-generation wireless communication technology. The server includes a high-performance processor (such as an Intel Xeon or an AMD EPYC CPU) and a large-capacity storage device (for example, SSD or NVMe storage). The server also includes software components: an operating system (such as Ubuntu Server or Windows Server), a high-speed database (for example, PostgreSQL, MySQL, or MongoDB) for accumulating data, and a generative artificial intelligence model implemented using a machine learning framework like PyTorch or TensorFlow and deployed using a serving platform such as TorchServe or custom API infrastructure. The terminal device is a computing apparatus such as an industrial tablet, a rugged smartphone, or an onboard controller (for example, an Android, iOS, or Windows IoT device). It runs a dedicated application, developed using frameworks like Flutter or React Native, to provide a user interface for displaying system instructions, accepting user interactions, and visualizing operational data and feedback. The user operates the terminal device to monitor workflows and movement routes, to observe progress indicators and environmental state, and to provide feedback and prompt sentences directly through intuitive graphical, textual, or voice input interfaces. The server receives real-time position information and surrounding information from the information processing devices and information acquisition devices using the network infrastructure. The information may include, for example, spatial coordinates, energy status, obstacle detection, temperature, humidity, and other environmental or operational parameters. Upon receiving this information, the server performs preprocessing, such as noise removal (for example, using a Kalman filter) and feature extraction (such as calculation of current speed, stop durations, obstacle encounter frequency), and applies pattern recognition (such as clustering or anomaly detection). The processed data is then formatted into suitable vectors or structures for the generative artificial intelligence model. The generative AI model on the server analyzes the input data and generates optimized operational procedures and movement routes for each information processing device. The user may input a prompt sentence to specify optimization constraints and objectives. For example, the user can enter: “Concentrate pickup operations between 9:00 and 11:00, and minimize traffic in Zone 5 due to ongoing maintenance.” The server computes the most suitable plans by combining sensor data, historical feedback, and user-supplied prompt sentences. The server then generates and transmits detailed command data (such as optimized movement routes and work schedules) to the terminal devices. The terminal device presents the received information as easy-to-understand visualizations (such as maps showing recommended routes, warnings about congestion zones, and prioritized work sequences), as well as interactive screens that allow the user to monitor progress, confirm results, and submit feedback. The user observes the terminal device display and, if necessary, provides dynamic feedback or another prompt sentence to refine system operation or correct unexpected issues. For example, the user might enter: “From 9:00 to 11:00, avoid refrigerated storage due to maintenance.” or “Prioritize outbound deliveries through Gate 2 during the next two hours.” The terminal device transmits this feedback and prompt sentence to the server, where such information is accumulated as historical data. The server uses this data to further train or fine-tune the generative artificial intelligence model, enabling continuous and adaptive improvements of operation plans, routes, and workflows. In this way, the system achieves real-time, high-precision optimization of operational processes, supports flexible adaptation to requirements in environments such as logistics centers and factories, and efficiently leverages human feedback to drive ongoing system enhancement. This embodiment may be flexibly implemented using various hardware, such as any suitable computing processor and storage, and software modules compatible with standard communication protocols and industry-standard machine learning frameworks.

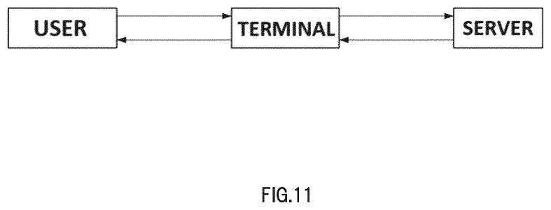

The following describes the processing flow using FIG. 11.

### Step 1

The server establishes secure communication channels with information processing devices and information acquisition devices via the network infrastructure. The server receives input data including real-time location information (such as spatial coordinates and timestamps) and surrounding information (such as temperature, humidity, energy state, and obstacle detection). As a concrete action, the server collects these data packets, validates their integrity, and stores them in a structured time-series database. The output of this step is a set of raw, timestamped sensor and device data entries aggregated on the server.

### Step 2

The server performs preprocessing on the aggregated raw data. The input for this step is the collected database entries from Step 1. The server applies noise removal algorithms (such as a Kalman filter), extracts features (such as device speed, duration at each checkpoint, or frequency of obstacle detection), and conducts pattern recognition to identify typical and anomalous behavior. The specific action includes converting raw sensor values into normalized feature vectors suitable for further analysis. The output consists of cleaned and structured feature data representing the operational status and environment for each device.

### Step 3

The server loads the generative AI model and prepares its input. The input for this step is the feature data from Step 2, along with any prompt sentences provided by the user. The server combines sensor-driven features and user-specified operational constraints or requests, and feeds them into the generative AI model implemented by a machine learning framework (such as PyTorch or TensorFlow). As a concrete action, the server invokes the model to generate optimized workflow procedures and movement routes for each information processing device. The output is a set of optimization instructions and detailed route plans for all active devices.

### Step 4

The server packages the optimization instructions and sends the data to the relevant terminal devices. The input here is the set of instructions and route plans from Step 3. The server formats these as structured messages (such as JSON objects) and transmits them over the network to the terminals. As a specific action, the server may include additional metadata, such as validity periods and alert levels, in the output.

### Step 5

The terminal receives and parses the optimization instructions from the server. The input for this step is the message package received from Step 4. The terminal device displays the assigned movement routes, workflow sequence, and warnings to the user using its application interface—for instance, graphically highlighting optimal routes on a map and showing areas of congestion or special instructions. The output is a set of visual and interactive elements on the terminal's user interface, ready for monitoring and further interaction by the user.

### Step 6

The user observes the terminal's display and confirms the progress of devices and operations. The input for this step is the information and visual feedback provided by the terminal. As a concrete action, the user can enter additional instruction or prompt sentences, such as requirements for scheduling, re-routing, or special handling (e.g., “Avoid Zone 5 due to maintenance” or “Batch pickups between 2 PM and 4 PM”). The output is user feedback and new prompt sentences input via the terminal's interface.

### Step 7

The terminal sends user feedback and prompt sentences to the server in real time. The input is the user-entered data from Step 6. The terminal validates the input and transmits it to the server as a feedback message. The output is successful delivery of user feedback and prompt sentences to the server for further processing.

### Step 8

The server aggregates user feedback and prompt sentences as historical data and incorporates them into the learning process for the generative AI model. The input is the set of feedback messages from the terminals. The server stores this information in a database and periodically uses it to retrain or fine-tune the generative AI model, improving the accuracy and responsiveness of future optimization steps. The output is an updated model and refined optimization capability based on cumulative operational experience and user input.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional logistics and operational management systems, it is difficult to achieve dynamic and real-time optimization of work flows and routes for mobile apparatuses, especially when considering fluctuating environmental factors and the physical and psychological conditions of human operators. Existing systems typically do not allow for intuitive user intervention or feedback to be reflected in operational planning, nor do they effectively utilize artificial intelligence to learn from ongoing feedback and improve over time. Moreover, difficulties remain in minimizing energy consumption and alleviating operator stress, particularly in environments where congestion or unexpected changes occur.

The specific processing by the specific processing unit 290 of the data processing device 12 in Application Example 1 is realized by the following means.

The present invention provides a server comprising a processor configured to analyze position data and physical environment data of mobile apparatuses, acquire operation and environment data in real-time via a high-speed wireless communication infrastructure, and generate optimized work flows and movement routes. The processor further incorporates a machine learning artificial intelligence model to autonomously update optimization strategies based on historical and feedback data, estimates a user's physical and psychological state using data supplied from a user terminal, and enables the user to intuitively control or modify work flow and movement route priorities. The system also performs appropriate adjustments in task planning or notification settings according to the estimated user state. This enables real-time adaptation of logistics operations to both environmental and human factors, providing increased efficiency, reduced energy consumption, and improved operator well-being in a flexible and responsive manner.

The term “processor” refers to a data processing unit or a computing device that executes instructions for data analysis, communication, optimization, and control tasks within the system. The term “mobile apparatus” refers to an autonomous or semi-autonomous moving device, such as a robot or vehicle, that performs transportation, delivery, or material handling within a facility. The term “external apparatus” refers to any peripheral or auxiliary device separate from the mobile apparatus, such as sensors, beacons, or monitoring systems, that provides supplementary data for analysis. The term “position data” refers to information indicating the geographical or spatial coordinates of objects, including but not limited to location, orientation, or movement history. The term “physical environment data” refers to information regarding the surrounding conditions in the operational environment, such as temperature, humidity, light, congestion, or obstacle presence. The term “work flow” refers to the sequence or arrangement of tasks, procedures, or operations performed by one or more apparatuses during the execution of a logistics or industrial process. The term “movement route” refers to the calculated or planned path taken by a mobile apparatus to move between locations while performing tasks or transporting goods. The term “information communication infrastructure” refers to a network system, including wired or wireless communication technologies, utilized for real-time data transmission between apparatuses, servers, and user terminals. The term “instruction” refers to control or command data sent from the processor to the mobile apparatus or user terminal, directing them to perform specified actions. The term “machine learning artificial intelligence model” refers to an algorithmic framework capable of autonomously learning patterns from historical and feedback data to improve optimization, prediction, or decision-making processes over time. The term “user terminal” refers to a human-machine interface device, such as a tablet, smartphone, or workstation, that allows a user to receive information, interact with the system, and provide input or feedback. The term “user's physical and psychological state” refers to the condition of a human operator, determined by factors such as fatigue, stress, attention, or other physiological and emotional parameters, estimated through data analysis or sensors. The term “task allocation” refers to the assignment and distribution of specific operations or jobs to mobile apparatuses or human operators according to an optimized plan. The term “evaluation information” refers to explicit or implicit feedback data provided by a user or automatically detected by the system regarding task execution, user experience, or system performance. The term “energy remaining value” refers to data indicating the current energy or power level of a mobile apparatus, such as battery status or fuel level. The term “obstacle data” refers to information about objects or conditions within the operational environment that may impede or alter the planned movement of a mobile apparatus. The term “high-speed wireless communication method” refers to advanced network protocols or standards that support rapid and reliable wireless data exchange, such as next-generation cellular or wireless LAN technologies.

In one embodiment of the present invention, the system comprises a server, one or more user terminals, and multiple mobile apparatuses operating within a controlled environment such as a warehouse or logistics center. The system also includes external apparatuses such as sensors and beacons to provide supplementary environmental data. Each component communicates via a high-speed wireless communication network, for example, using next-generation wireless LAN or cellular protocols. The server is implemented on a general-purpose computer or cloud-based architecture and runs backend software developed with a data processing framework such as Node.js. The server is configured to receive position data from the mobile apparatuses—equipped with GPS, LiDAR, or similar location-sensing modules—as well as environment data (such as temperature, humidity, and congestion) from external sensors. The server stores and manages these data in a relational database system, for example, an SQL-based server. The server is further configured with a machine learning artificial intelligence model framework, such as TensorFlow.js or a similar machine learning platform. This generative AI model is trained using accumulated historical data and user feedback recorded during operation. The model analyzes the current state—including live position and environment data, as well as recent user feedback—and generates optimized instructions for work flow and movement routes. The server then transmits these results as control instructions to the respective mobile apparatuses and user terminals via real-time communication protocols such as WebSocket or MQTT. The user terminal, such as a tablet, smartphone, or work station, is implemented with a user interface software using a platform such as React Native. The terminal receives the task sequence, movement route, and task allocation information from the server and visually presents this information on an interactive map and list interface. The terminal is further equipped with a camera and microphone, and may leverage a software development kit for emotion or state evaluation—such as a general-purpose cloud-based emotion recognition API or custom-built facial and voice analysis tools. The user operates the terminal to monitor system status, modify priorities, and provide feedback. The user may change the work flow or movement route priority directly through the touch interface, or by voice command. The terminal can display suggestions and prompt the user based on their detected physical or psychological state. Whenever the user provides explicit or implicit feedback, such as requesting a break or confirming a route, the terminal communicates this data back to the server for further analysis and model retraining. For example, suppose a warehouse worker is monitoring several mobile robots assigned to deliver perishable goods throughout a large facility. If sensors indicate high congestion near a loading dock and the emotion recognition engine detects that the worker appears stressed, the server will generate a prompt sentence for the generative AI model such as: “Given the current congestion near the loading dock and observed operator stress, please propose an optimized delivery route and break schedule for all robots over the next hour.” The generative AI model responds with a new workflow and movement plan that avoids congested areas and inserts a short break, which is then displayed on the terminal. The worker can approve or further adjust the plan as desired. This embodiment enables a closed-loop, adaptive operational management system. The integration of real-time data acquisition, generative AI optimization, and user state estimation ensures safe, efficient, and user-friendly logistics operations. The use of standard hardware such as commercially available servers, mobile devices, sensor modules, and software frameworks—including but not limited to Node.js, React Native, and TensorFlow.js—facilitates practical and scalable deployment.

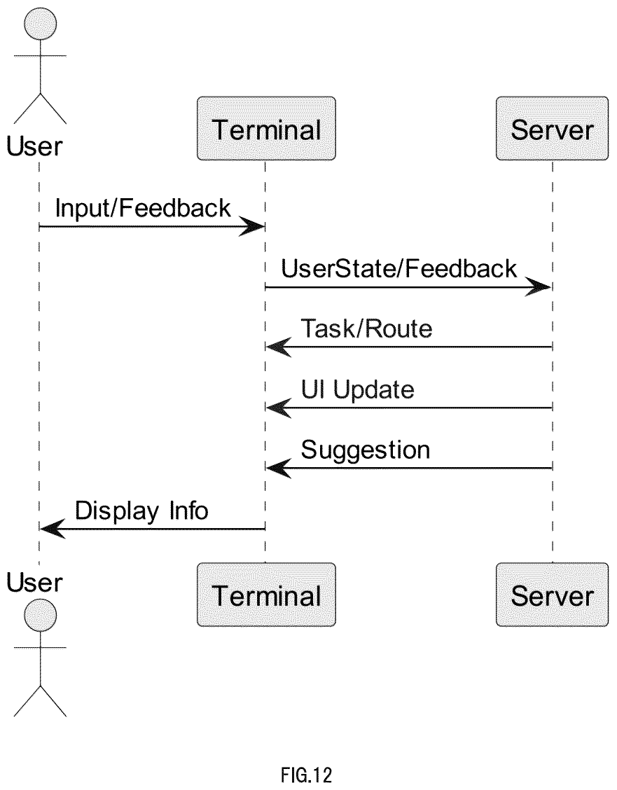

The following describes the processing flow using FIG. 12.

### Step 1

The server collects real-time position data and physical environment data from mobile apparatuses and external apparatuses via a high-speed wireless communication network. The input for this step includes GPS coordinates, sensor readings (such as temperature, humidity, and obstacle presence), and mobile apparatus status data. The server preprocesses and standardizes all data, converting it into unified formats, filtering out noise, and storing the processed data in a structured database. The output of this step is a set of cleaned and normalized status records for each apparatus and environment node.

### Step 2

The terminal captures user physical and psychological state data using its built-in camera and microphone. The input for this step consists of real-time audiovisual signals from the user while operating in the work area. The terminal uses emotion recognition software to analyze the user's facial expressions and voice tone, generating an estimated state category such as “calm,” “fatigued,” or “stressed.” This result is packaged and sent to the server. The output is a labeled state value representing the user's current estimated physical and psychological condition.

### Step 3

The server integrates the apparatus status records and the user state value. The input for this step comprises the cleaned apparatus/environment data and the user's current state label. The server correlates these inputs and detects patterns, such as high congestion correlating with user stress. The server creates a comprehensive status snapshot to be used for further optimization. The output is a combined context data package reflecting both environmental and human factors.

### Step 4

The server generates a prompt sentence for the generative AI model based on the combined status data. The input for this step is the comprehensive context data from Step 3. The server formulates a natural language prompt such as, “Given current congestion near storage zone B and high user stress, propose the optimal route and break schedule for all robots in the next hour.” The output is the generated prompt sentence.

### Step 5

The server inputs the prompt and recent operational history into the generative AI model, implemented with a machine learning framework. The input includes the prompt sentence, historical records, and previous user feedback. The generative AI model performs inference, using pattern recognition and learned strategies to predict an optimal workflow, such as re-routing robots and recommending breaks. The output is an updated set of task allocations and movement routes.

### Step 6

The server transmits the optimized workflow, task allocations, and movement routes to both the mobile apparatuses and user terminals. The input for this step is the output of the generative AI model comprising concrete instructions. The server uses real-time communication methods such as WebSocket or MQTT to send these instructions. The output is the delivery of new task orders and route plans, in machine-readable form, to each apparatus and user terminal.

### Step 7

The terminal receives the new instructions and renders them for the user on an interactive interface. The input is the received workflow, allocations, and routes from the server. The terminal displays robot positions and task sequences visually on a map, and allows the user to adjust the order by drag-and-drop or by voice command. The terminal processes user modifications and sends them to the server as feedback. The output is a synchronized user interface reflecting the current task plan and user adjustments.

### Step 8

The user interacts with the terminal, monitoring operational progress and providing explicit or implicit feedback. The input includes visual and audio interface prompts, real-time task status, and suggestions from the system. The user may acknowledge, modify, or provide feedback on the plan—such as requesting a break or optimizing task priority. The terminal packages user input and returns it to the server. The output is a set of user feedback data and modification requests.

### Step 9

The server receives ongoing user feedback and new environment data, and continuously retrains its generative AI model (offline or at scheduled intervals). The input for this step is the aggregated historical data, feedback logs, and performance metrics. The server updates the model weights and strategies for future predictions. The output is an improved machine learning model capable of providing even more optimized task allocation and route planning in subsequent cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventionally, workflow optimization systems have not sufficiently taken into account the emotional state of users, resulting in excessive workload or decreased operational efficiency, particularly in environments where real-time adaptation is necessary. Existing systems also face challenges in integrating diverse sensor data, such as physical environment information and user feedback, for dynamic optimization. Furthermore, limitations in communication technology can impede the timely transfer and processing of critical data, thus reducing the effectiveness of the workflow system in user-centric and rapidly changing contexts.

The specific processing by the specific processing unit 290 of the data processing device 12 in Example 2 is realized by the following means.

The present invention provides a server comprising a processor configured to analyze location and physical environment information acquired from mobile and peripheral devices, process user voice and image data using an emotion analysis apparatus to estimate the user's emotional state, generate prompt sentences based on analysis data and estimated emotional state, and input said prompt into a generative artificial intelligence model to produce optimized workflow, movement routes, and work allocation adapted to the user's emotional state; further, the server sends instructions to a terminal for display to the user, receives feedback data from the terminal, and continuously adapts the workflow in real time using a high-efficiency communication infrastructure. This enables a highly adaptive workflow management system that dynamically minimizes user burden and maximizes operational efficiency by integrating multi-modal data and real-time user feedback into advanced artificial intelligence-driven optimization.

The term “processor” refers to an information processing unit or hardware capable of executing software instructions, data analysis, and control operations within the system. The term “mobile device” refers to any movable apparatus equipped with location sensing capability, such as a robot or portable terminal, capable of transmitting data to the system. The term “peripheral device” refers to an auxiliary apparatus or sensor, such as an environmental sensor, that operates in conjunction with the mobile device for collecting additional data required for system optimization. The term “location information” refers to data indicating the current position of a mobile device or peripheral device, typically represented by geographic coordinates. The term “physical environment information” refers to data describing measurable aspects of the surroundings in which the system operates, including but not limited to temperature, humidity, light, and obstacle information. The term “workflow procedures” refers to a sequence of work-related tasks and processes that a user is expected to perform within the operational context of the system. The term “movement routes” refers to planned or optimized paths that a mobile device or user should traverse within a given space, as determined by the system. The term “communication infrastructure” refers to the network technologies and protocols used to facilitate real-time data transmission between system components, including but not limited to wireless and wired communication technologies. The term “user” refers to an individual interacting with the system, who may provide feedback and receive work instructions through a human-machine interface. The term “input information” refers to any data actively or passively provided by the user to the system, including voice, image, and behavioral feedback. The term “emotion analysis apparatus” refers to hardware or software designed to analyze user data, such as voice and image, in order to estimate the emotional state of the user. The term “emotional state” refers to a quantified or classified aspect of the user's psychological condition, such as stress, fatigue, or positivity, determined from voice, expression, or behavior. The term “prompt sentence” refers to a syntactically structured input statement, constructed from analysis data and emotional state estimations, which is submitted to the generative artificial intelligence model. The term “generative artificial intelligence model” refers to a computerized model applying artificial intelligence, such as a neural network or language model, to generate optimized workflow, movement routes, and instructions based on provided input data. The term “task allocation” refers to the distribution or assignment of specific work-related tasks to a user or mobile device, as determined by the system to maximize efficiency and adaptiveness. The term “terminal” refers to an output device, such as a display-equipped user interface unit, that presents instructions to the user and collects feedback. The term “user interface” refers to the means by which instructions, notifications, and data are presented to the user, and by which the user responds or provides feedback to the system. The term “feedback information” refers to data generated by the user's interaction with the system, such as response actions, behavioral data, or updated voice and image inputs, which are used for subsequent analysis and optimization. The term “high-efficiency communication technology” refers to advanced network technologies and protocols enabling rapid, reliable, and real-time transfer of data among system components.

An embodiment for implementing the present invention is described as follows. The system comprises a server equipped with a processor, a communication infrastructure, one or more mobile devices, peripheral devices, and a terminal with a user interface. The server may be constructed using a general-purpose computing platform, such as an x86 or ARM-based server running a Linux operating system. The server is capable of executing software implemented with languages and frameworks including Python, TensorFlow, PyTorch, Pandas, and scikit-learn. The server receives data from mobile devices and peripheral devices via the communication infrastructure. The mobile devices can be implemented as autonomous robots or portable terminals equipped with a GPS module and wireless communication capability. The peripheral devices may include environmental sensors such as temperature, humidity, or obstacle sensors, which are capable of transmitting measured data to the server through wired or wireless protocols like Wi-Fi, Bluetooth, or Zigbee. The server utilizes an acquisition module that regularly collects location information and physical environment information from the connected devices. The incoming data undergo data cleansing and preprocessing by the server using, for example, Python scripts with the Pandas library to interpolate missing values and normalize sensor readings. The terminal is realized as, for example, a tablet or smartphone equipped with a microphone, camera, and speaker. The terminal captures voice and facial images of the user and transmits these data to the server. The server processes received audio by applying speech recognition technology such as a general voice-to-text API, and processes facial images with an image analysis algorithm, for example, utilizing OpenCV or other commercial facial emotion detection software. The server executes an emotion analysis apparatus implemented in software, which analyzes the processed audio and image data to estimate the user's emotional state. This is achieved using a machine learning model, such as a neural network developed with TensorFlow or PyTorch. The emotional state is quantified as scores for attributes such as stress, fatigue, or mood positivity. The server then prepares a prompt sentence that summarizes the current context based on the cleaned location and environment data and the estimated emotional scores. The prompt sentence is submitted to a generative AI model, such as a large language model, which is implemented on a high-performance server or accessed via a cloud API. The generative AI model analyzes the prompt sentence and produces optimized workflow instructions, movement routes, and allocation of tasks adapted to the user's current emotional state and context. The server transmits these optimized instructions to the terminal using a standard message delivery protocol, such as MQTT or push notification service. The terminal displays the received instructions to the user through the user interface and may utilize a Text-to-Speech engine for auditory delivery. The terminal is also configured to adjust the way information is presented, such as reducing notification frequency or altering interface complexity in accordance with the user's emotional status. The user performs the suggested tasks according to the instructions presented on the terminal and provides feedback either explicitly by responding on the user interface or implicitly through voice and facial expressions captured by the terminal. The feedback data is transmitted to the server, which incorporates this new information into the next processing cycle, allowing for continuous adaptation of workflows and instructions in real time. For example, when a user shows signs of high stress (as detected by the emotion analysis apparatus), the server sends the following prompt sentence to the generative AI model: “If the user shows an anxious facial expression and raises their voice, suggest how notification frequency and work allocation should be adjusted to reduce stress.” Based on the output from the generative AI model, the server might instruct the terminal to reduce the number of alerts and suggest a short break to the user. The terminal then displays and speaks: “Non-critical tasks are postponed. Please take a water break. You're doing well!” Following this, if the user's mood improves (as indicated by a detected smile and relaxed voice recorded by the terminal), this positive feedback is further incorporated into the ongoing system optimization. With this structure, the system enables dynamic, user-centric workflow management by integrating multi-modal data acquisition, advanced data processing, artificial intelligence-driven optimization, and adaptive user interfaces. This approach ensures both reduced burden on the user and increased operational efficiency.

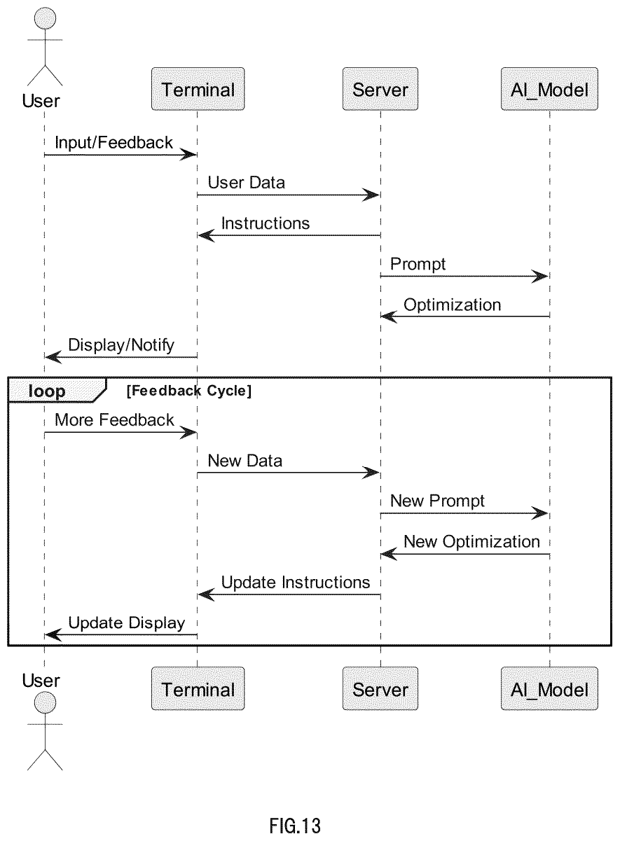

The following describes the processing flow using FIG. 13.

### Step 1

The server collects location data and physical environment data from mobile devices and peripheral devices at regular time intervals. The server receives inputs such as GPS coordinates, temperature, humidity, and obstacle sensor values via the communication infrastructure. The server performs data cleansing and normalization using a Python script with the Pandas library to interpolate missing values and filter out anomalies. The output is a cleaned dataset containing up-to-date device status and environmental information.

### Step 2

The terminal captures the user's voice via the microphone and facial images via the camera while the user interacts with the device. The input includes raw audio and image data. The terminal transmits these inputs to the server. The output is a set of audio and image files uploaded to the server for further analysis.

### Step 3

The server processes the received audio and image data. The server uses a speech-to-text service to convert voice data into text and employs an image processing library, such as OpenCV, to analyze facial expressions. The server uses a machine learning model, implemented with TensorFlow, to extract emotional scores such as stress and fatigue from the processed data. The input comprises the text transcript and facial features data, and the output is a set of quantified emotional state scores.

### Step 4

The server generates a prompt sentence that summarizes the user's current context using the cleaned environment data and the emotion scores. The server submits this prompt to the generative AI model via an API call. The input is the set of structured context attributes and emotional scores; the server constructs a descriptive and contextually relevant prompt. The output is a prompt sentence delivered to the generative AI model.

### Step 5

The server receives the optimized workflow instructions and movement routes generated by the generative AI model. The server parses and formats these outputs into actionable directives, such as optimized task lists, route changes, and notification preferences. The input is the response from the generative AI model; the output is a structured set of instructions to be communicated to the terminal.

### Step 6

The server sends the formatted instructions to the terminal in real time using a push notification service or message queue protocol. The input is the server's generated instructions, and the output is the successful delivery of instruction packets to the terminal.

### Step 7

The terminal receives the instructions and updates the user interface to display the new workflow and notifications. The terminal utilizes a Text-to-Speech engine to read relevant instructions aloud when appropriate. The input is the instruction packet from the server; the terminal formats and presents tasks and notifications, adjusting the presentation style according to the user's emotional state. The output is visible and audible guidance for the user.

### Step 8

The user interacts with the terminal by following the task instructions, completing assigned activities, and providing explicit or implicit feedback through actions, voice, or facial expressions. The input is the displayed instructions and guidance; the output is a set of user behaviors and feedback data, including UI interactions and sensor-captured images and audio.

### Step 9

The terminal collects the user's feedback, including new audio and image data, and logs of user responses or actions. The input is the continuous set of behavioral and biometric data from the user. The terminal transmits these feedback data to the server for the next process cycle. The output is an updated feedback dataset integrating new user state information.

### Step 10

The server receives the new feedback data and incorporates it into the processing cycle. Based on the feedback, the server recalculates or updates the user's context, emotional state, and workflow optimization as required. The input is the updated feedback dataset; the output is a renewed set of environment data, user state data, and, if necessary, a new prompt constructed for the generative AI model, closing the adaptive system loop.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional work environments, it is difficult to dynamically optimize operational procedures and travel routes of mobile objects while also considering the emotional state of human operators. Traditional systems typically focus solely on efficiency improvements without providing real-time feedback or emotional support to workers, which can lead to increased stress, fatigue, and reduced productivity. Moreover, existing solutions do not adequately leverage advanced artificial intelligence models to adapt workflows or provide relaxation guidance tailored to an individual's current condition. There is a need for a system that integrates real-time data acquisition, workflow optimization, emotion recognition, and adaptive guidance, thereby achieving both enhanced operational efficiency and reduction of emotional burden on human operators.

The specific processing by the specific processing unit 290 of the data processing device 12 in Application Example 2 is realized by the following means.

The present invention provides a server comprising a processor configured to analyze position data and environment data from a mobile object and an external device, optimize work procedures and travel routes, acquire real-time movement and environment data, generate optimized instructions, analyze emotion state information of a person from a terminal, dynamically adjust workflows based on emotional status, generate prompt sentences for a generative artificial intelligence model, present guidance through visual and auditory means, receive feedback from the operator, and continuously optimize operational plans based on this feedback and emotion data. This enables a dynamic and adaptive work management system that not only improves productivity and safety, but also supports the emotional well-being of operators through the integration of real-time analytics, artificial intelligence, and personalized feedback.

The term “processor” refers to a computing unit capable of executing instructions and performing data processing operations. The term “mobile object” refers to any movable machine or device capable of autonomous or controlled movement within a physical environment. The term “external device” refers to any hardware or unit operating in conjunction with the mobile object and providing additional data or functions, such as sensors or other peripheral equipment. The term “position data” refers to information indicating the geographic or spatial location of the mobile object or external device. The term “environment data” refers to information regarding physical conditions surrounding the mobile object or external device, including but not limited to temperature, humidity, and other relevant environmental parameters. The term “work procedure” refers to a sequence of actions or processes executed to accomplish a specific task or objective in an operational environment. The term “travel route” refers to the planned path or course that a mobile object follows to move from one location to another. The term “communication arrangement” refers to an infrastructure or technology that facilitates the transmission and reception of data between system components. The term “movement data” refers to information related to the motion status or activities of the mobile object. The term “real time” refers to the processing or transmission of data with minimal delay, enabling immediate action or feedback. The term “work allocation” refers to the distribution of specific tasks or responsibilities among available resources within a workflow. The term “emotion analysis apparatus” refers to a device or software module configured to assess and classify the psychological or emotional state of a person based on input such as facial images or voice data. The term “emotion state information” refers to data representing the psychological or emotional status of a person, including indicators of stress, relaxation, or other affective states. The term “terminal” refers to a user interface device employed by a person to receive instructions or provide feedback, which may include a display, audio output, camera, or microphone. The term “prompt sentence” refers to a query or instruction automatically generated and input into a generative artificial intelligence model for the purpose of obtaining guidance or solution suggestions. The term “generative artificial intelligence model” refers to an advanced computational system capable of producing content or responses based on natural language input. The term “visual and auditory means” refers to methods of presenting information through display screens, graphics, text, voice output, or sound effects. The term “relaxation guidance” refers to recommendations or instructions provided to a person to help reduce psychological or physical stress. The term “feedback information” refers to data input from a person reporting their condition, actions taken, or responses to system guidance. The term “object detection data” refers to information obtained from sensors or other means indicating the presence, position, or characteristics of obstacles or items in the operational environment. The term “power supply level data” refers to information indicating the remaining energy or battery status of the mobile object.

An embodiment for implementing the present invention is described below in detail. The system comprises a processor, which may be realized by a general-purpose computing device such as a server, and a network of terminals, such as mobile devices or user interface devices. The server may employ hardware including a central processing unit (CPU), memory, data storage apparatus, and network interface modules. Suitable server hardware includes, for instance, rack-mounted industrial computers or high-performance workstations. The server is connected to an environment in which one or more mobile objects (such as robots, vehicles, or automated guided machines) and external devices (such as environmental sensors, cameras, or RFID readers) operate. Terminals may include tablet computers, smartphones, or dedicated handheld devices, equipped with displays, speakers, microphones, and cameras. The server executes software modules—such as a generation module for analyzing location and environmental data and optimizing workflows, one or more database management systems for storage (e.g., MySQL, PostgreSQL), communication modules (e.g., MQTT, HTTP, or WebSocket protocols), and an emotion analysis apparatus, which may be implemented with artificial intelligence software such as TensorFlow, PyTorch, or OpenCV for image and voice recognition. The server may host and connect to an external or internal generative artificial intelligence model specialized for workflow support (e.g., a large language model). The server collects position data and environment data continuously from mobile objects and external devices. Examples of environment data include temperature, humidity, and object detection information. These data are processed in real time to generate an optimized work procedure and travel route for each mobile object or human operator. The optimization algorithms employed may include path planning algorithms (such as Dijkstra or A*) and resource scheduling algorithms, implemented in programming languages including Python or C++. Simultaneously, the server receives emotion state data, such as facial images or voice data, from the terminal utilized by the user. The emotion analysis apparatus processes these data to assess stress, fatigue, or relaxation levels. If a stressed state is detected, the system dynamically alters workflows—reducing difficult assignments, adjusting notification frequency, or inserting rest periods. Furthermore, the server generates a prompt sentence for the generative artificial intelligence model. This prompt is used to obtain tailored suggestions for workflow adjustment or relaxation guidance. An example of such a prompt sentence is:
“How can I reduce the fatigue I feel in my current work situation?”
   Another example is:
“Generate a relaxation instruction suitable for workers in high-temperature environments who are currently showing signs of stress.”
   The AI model's response is then incorporated into the guidance displayed to the operator. The terminal receives work plans, notifications, and relaxation guidance from the server. Information is provided visually on a display or auditorily using speech synthesis modules (such as Google TTS). If relaxation guidance is issued, the terminal may present animated instructions for deep breathing or play ambient sound for stress reduction. The user, such as a factory operator or field worker, interacts with the terminal, following the provided instructions and inputting feedback as needed. The user's actions—such as confirming task completion or rest period adherence—are communicated back to the server via the terminal. Feedback may also include new emotion state data gathered automatically via the terminal's camera or microphone. The server continuously updates workflow plans and guidance using feedback received from the user and emotion analysis results. Communication throughout the system may utilize next-generation wireless standards (such as 5G). By integrating real-time workflow optimization, emotion recognition, generative AI-supported guidance, and feedback collection, the described embodiment achieves both enhanced operational efficiency and improved emotional well-being of users.

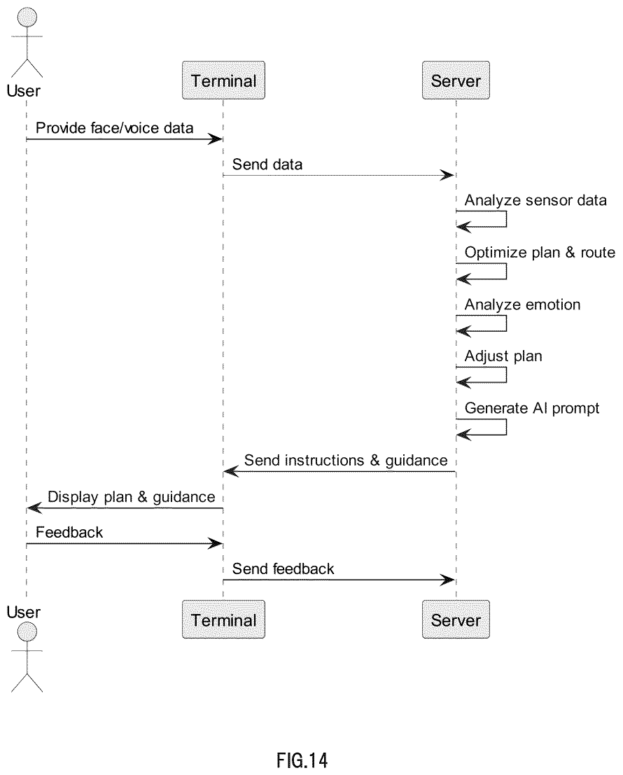

The following describes the processing flow using FIG. 14.

### Step 1

The server acquires location data and environment data from mobile objects and external devices. As input, the server receives signals including GPS coordinates, temperature, humidity, and object detection data via communication protocols such as MQTT or HTTP. The server processes these raw inputs by formatting the data and storing them in a structured database. The output of this step is a series of organized records containing the current state of each device and its surroundings.

### Step 2

The server analyzes the collected location data and environment data using the generation module. As input, the server pulls relevant records from the database. Data processing is performed by applying optimization algorithms (such as Dijkstra's or A* for route planning and resource allocation algorithms for task scheduling). The server outputs an optimized work procedure and travel route plan for each mobile object or user, specifying paths, task assignments, and schedules.

### Step 3

The terminal collects emotion state data from the user. As input, the terminal uses its camera and microphone to capture facial images and voice samples while the user works. The terminal preprocesses these signals by converting images and sound into digital data streams, which are securely sent to the server. The output is a set of emotion-related data features transmitted for analysis.

### Step 4

The server performs emotion analysis to assess the user's current emotional state. As input, the server receives preprocessed emotion data from the terminal. The server uses an artificial intelligence module (for example, a deep learning model in TensorFlow or PyTorch) to analyze features and classify the user as relaxed, neutral, or stressed. The output is a label or score representing the emotional state of the user.

### Step 5

The server adjusts the work procedure and scheduled notifications based on the emotional state and operational data. Inputs are the optimized plan from Step 2 and the emotion label from Step 4. Data computation involves rule-based logic or adaptive scheduling: if the user is stressed, the server reduces workload intensity or increases break frequency. The output is a dynamically updated work plan and set of guidance instructions customized for the user's current condition.

### Step 6

The server generates a prompt sentence for the generative AI model to further enhance user support. As input, the server uses current operational status and emotion analysis results to formulate an appropriate query (for example, “How can I reduce the fatigue I feel in my current work situation?”). The prompt is transmitted to the generative AI model, and the model's textual guidance is received as output.

### Step 7

The terminal receives the updated work plan, notifications, and AI-generated relaxation guidance from the server. As input, the terminal accepts data packets containing instructions, break recommendations, and text-based advice. The terminal processes this input to present information visually on the screen and aurally via speakers, utilizing text-to-speech modules if necessary. The output is delivered to the user in an accessible, interactive manner.

### Step 8

The user performs the instructed tasks, follows guidance for relaxation, and provides feedback through the terminal. The user's inputs include confirmations of completed tasks, responses to guidance, and implicit feedback via facial expressions or voice changes. This feedback is processed by the terminal, which digitizes the data and sends it to the server for further analysis. The output is new behavioral and emotion data that re-enter the system.

### Step 9

The server continuously integrates feedback and emotion data to refine workflow and guidance. As input, the server aggregates the latest feedback and emotion records. Using adaptive algorithms, the server updates scheduling logic and support content for subsequent cycles. The output is an ever-improving operational plan and support system tailored to maintain both efficiency and user well-being.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

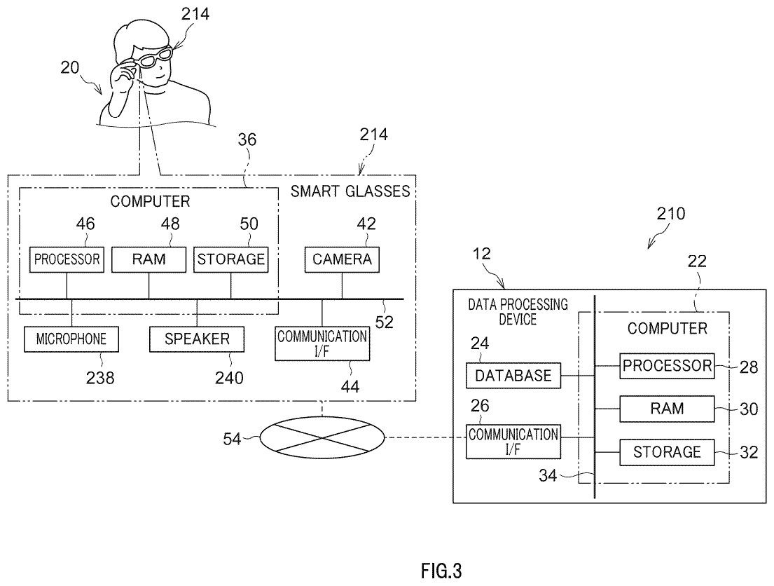

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

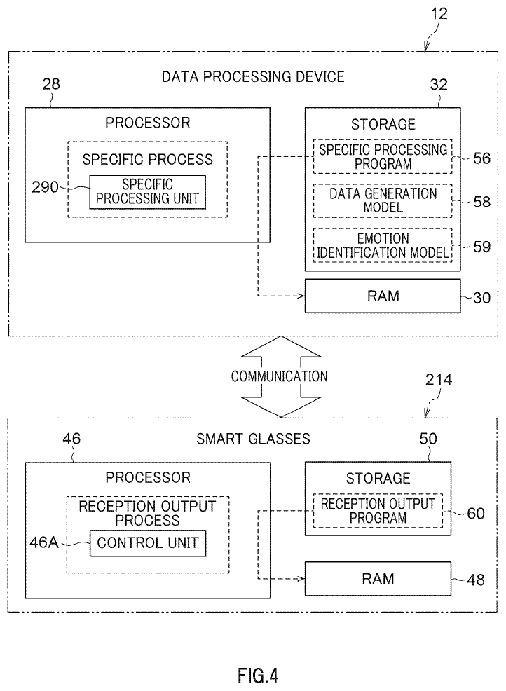

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

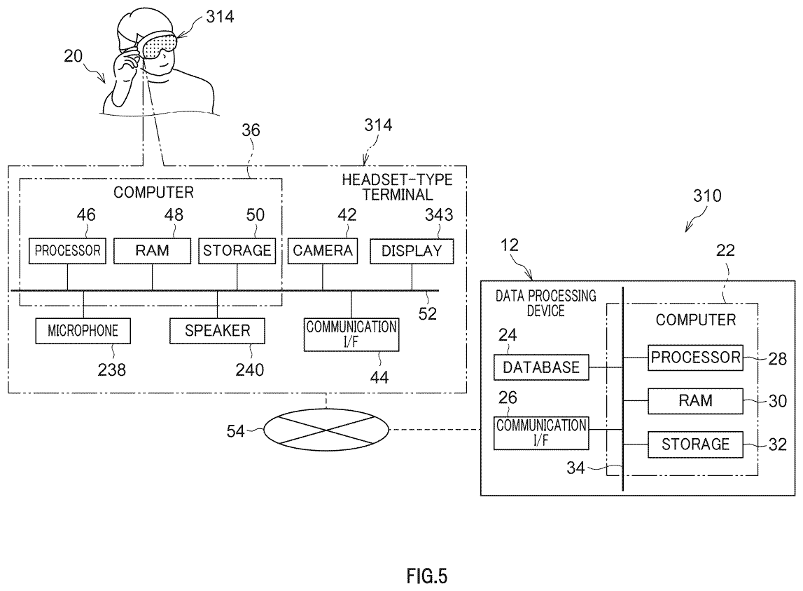

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

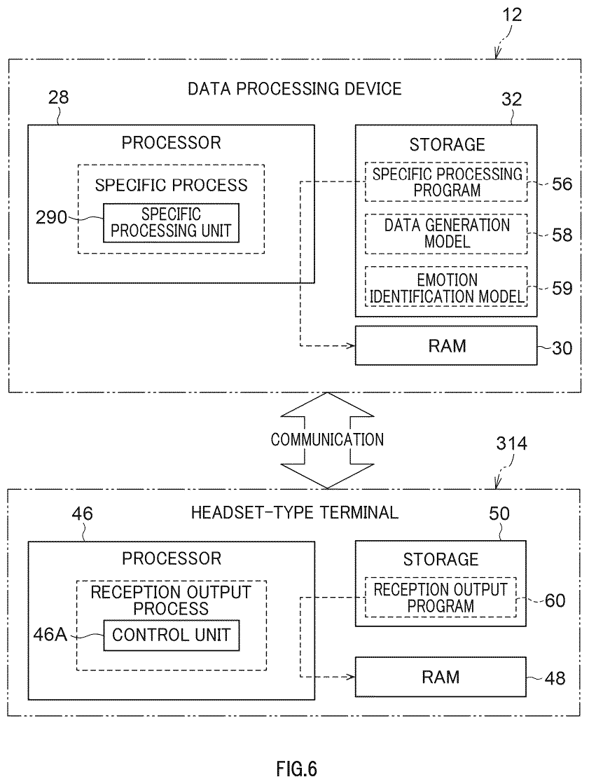

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

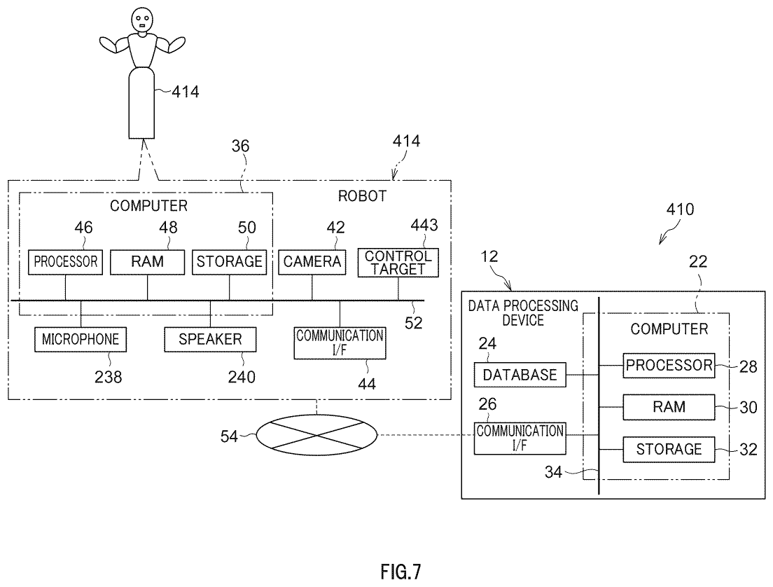

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

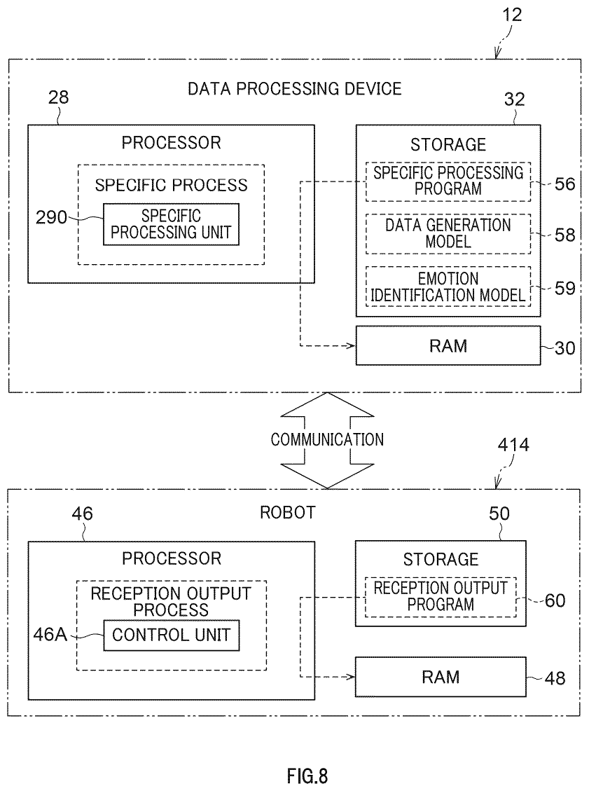

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

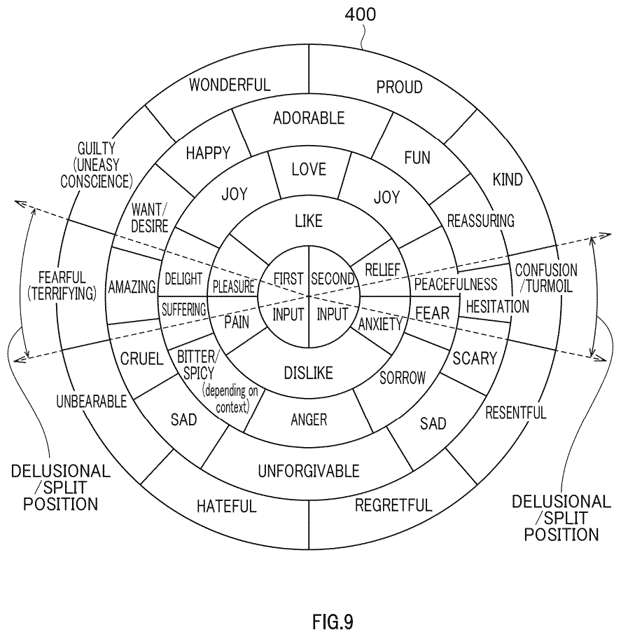

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

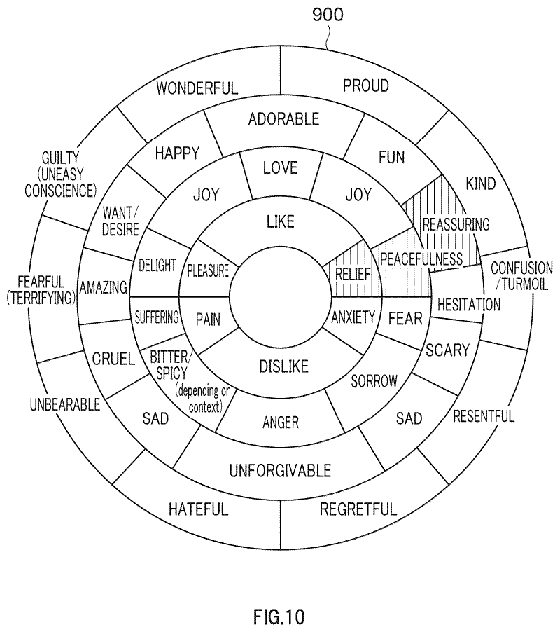

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, wherein the processor is configured to perform preprocessing including noise removal, feature extraction, and pattern recognition on location information and surrounding information acquired from an information processing device and an information acquisition device, and then execute a generative artificial intelligence model to perform optimization and optimize workflow and movement routes; acquire data in real time from the information processing device and the information acquisition device by using a network infrastructure and aggregate and store said data in the processor; calculate optimized operation routes and task allocation for the information processing device based on analysis results and prompt sentences input by a user, by using the generative artificial intelligence model, and transmit command data to a terminal device; cause the terminal device to visualize and display the command data, accept operation or input from the user via a user interface, and transmit feedback information from the user to the processor; and accumulate feedback information and prompt sentences from the user as historical data and utilize the historical data as training data and optimization parameters for the generative artificial intelligence model.

### Supplementary 2

The system according to supplementary 1, wherein the processor is configured to analyze data including energy residual information, obstacle presence information, work progress information, and environmental condition information of the information processing device.

### Supplementary 3

The system according to supplementary 1, wherein the processor is configured to use a high-speed wireless communication technology or next-generation communication technology as the network infrastructure.

### Application Example 1

### Supplementary 1

A system comprising a processor, wherein the processor is configured to analyze position data and physical environment data acquired from a mobile apparatus and an external apparatus to optimize a work flow and a movement route, acquire operation data and physical environment data in real-time using an information communication infrastructure, generate an optimized route and task allocation for the mobile apparatus and transmit an instruction based on the analysis result, utilize a machine learning artificial intelligence model to continuously optimize the work flow and movement route using past records and evaluation information provided by a user, estimate a user's physical and psychological state via a user terminal and provide the estimate to the processor, allow the user to intuitively control or modify the priority of the work flow and movement route through the user terminal, and perform a process in which the optimization of the work flow or adjustment of the notification frequency is carried out based on the user's physical and psychological state.

### Supplementary 2

The system according to supplementary 1, wherein the processor is configured to analyze data including an energy remaining value of the mobile apparatus, obstacle data, and an evaluation index of the user's physical and psychological state.

### Supplementary 3

The system according to supplementary 1, wherein the information communication infrastructure comprises a high-speed wireless communication method.

### Example 2

### Supplementary 1

A system comprising a processor, wherein the processor is configured to analyze location information and physical environment information received from a mobile device and a peripheral device, and optimize workflow procedures and movement routes; acquire, in real time, location data, physical environment data, and input information from a user via a communication infrastructure; analyze user voice data and image data using an emotion analysis apparatus to estimate an emotional state of the user; input a prompt sentence, based on the analysis data and the estimated emotional state, into a generative artificial intelligence model, and optimize workflow procedures, movement routes, and task allocation to adapt to the user's emotional state, and generate optimized instructions for transmission to a terminal; display received instructions on a user interface of the terminal and acquire feedback information from the user; and collect the feedback information from the user by the processor, and continuously adapt the processing cycle.

### Supplementary 2

The system according to supplementary 1, wherein the processor is configured to analyze data including power source residual information of the mobile device, obstacle information, and biometric information of the user.

### Supplementary 3

The system according to supplementary 1, wherein the communication infrastructure uses high-efficiency communication technology.

### Application Example 2

### Supplementary 1

A system comprising a processor, wherein the processor is configured to analyze position data and environment data acquired from a mobile object and an external device, and optimize a work procedure and a travel route; obtain movement data and environment data in real time using a communication arrangement; generate, based on analysis results, an optimized travel route and work allocation for the mobile object, and transmit instructions; analyze, via an emotion analysis apparatus, emotion state information of a person collected from a terminal, and dynamically adjust the work procedure and notification frequency based on the analysis results; generate a prompt sentence for a generative artificial intelligence model, and automatically update the work procedure and advice information to an operator based on an output from the generative artificial intelligence model; cause the terminal to provide information presentation by visual and auditory means, and carry out relaxation guidance according to the state of the person; receive, from the person via the terminal, feedback information; and continuously optimize the work procedure and related elements using the feedback information and the emotion state information.

### Supplementary 2

The system according to supplementary 1, wherein the processor is configured to analyze as target data a power supply level data of the mobile object and an object detection data.

### Supplementary 3

The system according to supplementary 1, wherein the communication arrangement applies a next-generation communication method.

What is claimed is:

1. A system comprising a processor,
wherein the processor is configured to:
analyze position information and environmental information received from a mobile device and a peripheral device using a generation module,
acquire real-time movement data and environmental information utilizing a communication infrastructure, and
generate optimized workflows and movement routes, and
transmit instructions to the mobile device based on the analysis results.

2. The system according to claim 1, wherein the data to be analyzed includes battery status of the mobile device and obstacle information.

3. The system according to claim 1, wherein the communication infrastructure uses next-generation communication technology.
